(19) United States
(12) Patent Application Publication
(10) Pub. No.: US 2026/0212668 A1
(43) Pub. Date: Jul. 23, 2026

(54) METHODS AND SYSTEMS FOR DETERMINING SUSTAINABILITY OF AGRICULTURAL FIELDS, FARMLANDS AND OTHER VEGETATION AREAS

(71) Applicant: DIGIFARM AS, Hamar (NO)

(72) Inventors: Alexei MELNITCHOUCK, Calgary, Alberta (CA); Konstantin VARIK, Javea Alicante (ES); Nils Solum HELSET, Ridabu (NO); Yosef AKHTMAN, St-Prex (CH)

(21) Appl. No.: 19/140,904

(22) PCT Filed: Dec. 18, 2023
(86) PCT No.: PCT/NO2023/060129

§ 371 Date: Jun. 18, 2025

(30) Foreign Application Priority Data
Dec. 19, 2022 (NO) 20221362

(51) Int. Cl. G06V 20/10; G06V 10/764; G06V 10/82; G06V 20/13

(52) U.S. Cl. CPC G06V 20/188; G06V 10/764; G06V 10/82; G06V 20/13

(57) ABSTRACT

A method in a computer system for estimating vegetation sustainability for an area (301). At least one multispectral image (101) of the area (301) is obtained from respective growing seasons. For the respective growing seasons, vegetation indices are derived (203) for locations within the area (301) based on the multispectral information in the at least one multispectral image. A vegetation index value (501, 503) representative of the area (301) as a whole is then calculated (204) from the derived vegetation indices. The vegetation index values (501, 503) representative of the area as a whole from the respective growing seasons are used to quantify (206) a trend (502, 504) in yield potential over time for the area (301) and to analyze vegetation sustainability based on the quantified trend (502, 504). A corresponding computer-based system is also described.

### TECHNICAL FIELD

The present invention relates to sustainable agriculture. In particular, it relates to methods and corresponding systems for determining the sustainability of agricultural fields but may also be applied to larger farmlands or other vegetation areas.

### BACKGROUND

Sustainability is a fundamental requirement in the agricultural industry. Crop and livestock production must not just use the natural resources but also ensure that those resources are replenished through the right farm management practices.

Sustainability is defined as “farming in sustainable ways meeting society's present food and textile needs, without compromising the ability for current or future generations to meet their needs” (“What is sustainable agriculture|Agricultural Sustainability Institute”. https://sarep.ucdavis.edu/sustainable-ag. 11 Dec. 2018. Retrieved 2019 Jan. 20). This means that in order to be sustainable, crop production should maintain existing natural resources at the existing level, or improve them over the time, in order to preserve these resources for future generations.

Agricultural industry is very fragmented and region-specific. Various crops are produced in various geographic regions and employ completely different farming technologies and practices. Until now, there has been no universal, accurate, and scalable tool for measuring the level of sustainability in different geographic areas. For example, some of the methods used in North America for quantification of carbon credits based on zero tillage on farms (also known as no-till farming) cannot be applied in other agricultural regions where heavy soils require tillage for crop production. Other methods, such as modeling soil carbon content, have low accuracy and require a large amount of ground data for calibration.

There is therefore a need for simple, automated and, therefore, scalable methods for analyzing the level of sustainability in crop production for any agricultural field on Earth, regardless of the field size, soil composition, crops grown in the field, and geographic region.

### SUMMARY OF THE DISCLOSURE

In order to address these needs, the present invention provides a method implemented in a computer system for estimating vegetation sustainability for an area. The method comprises obtaining at least one multispectral image of the area from respective growing seasons, and for the respective growing seasons, deriving vegetation indices for locations within the area from the multispectral information in the at least one multispectral image and calculating a vegetation index value representative of the area as a whole from the derived vegetation indices for locations within the area. The vegetation index value representative of the area as a whole from the respective growing seasons is used to quantify a trend in yield potential over time for the area and to provide a sustainability index based on the quantified trend.

In some embodiments of the invention the step of obtaining at least one multispectral image of the area from respective growing seasons includes obtaining a plurality of cloud-free multispectral satellite images collected close to the peak of at least one growing season. The step of calculating a vegetation index value representative of the area as a whole for the at least one growing season may then include calculating a vegetation index value for the respective images for that growing season and selecting the image with maximum vegetation index value for the area as a whole as representative of that growing season.

The multispectral images do not necessarily include information regarding which part or parts of the image that relate to the area of interest and which parts do not. Therefore, some embodiments of the invention are configured to obtain delineated area boundary information and, in the step of obtaining at least one multispectral image of the area from a plurality of growing seasons, applying the delineated area boundary information to remove multispectral information relating to locations outside the area boundary.

Obtaining the boundary information may include obtaining at least one multitemporal, multispectral satellite image sequence from an earth observation satellite system, improving the resolution of the multitemporal, multispectral satellite image sequence with a super-resolution method to generate a high-resolution image sequence where corresponding pixel positions in images in the sequence relate to the same geographical ground position, and using a delineating artificial neural network to classify pixel positions in the high-resolution image sequence as being associated with a geographical ground position that is or is not part of the area.

However, in some cases delineated area boundary information may be available from a public repository such as a database. Some embodiments of the invention are therefore configured to obtain delineated area boundary information from such a database.

Different methods may be used to analyze the vegetation index values. Some embodiments of the invention are configured to, in the step of using the vegetation index value to quantify a trend, perform regression analysis on the vegetation index values from the respective growing seasons.

In accordance with the invention, the analysis may provide output indicating that if the trend in yield potential over time is stable or increasing the area is sustainable, and if the trend is negative the area is not sustainable.

The area being analyzed may vary based on the kind of input the system receives and how the system is configured to process this input. As such, the area may be a contiguous or non-contiguous area selected from the group consisting of: an agricultural field, a municipal area, an agricultural area, a forest, and a vegetation region.

According to another aspect of the invention a computer-based system is provided for estimating vegetation sustainability for an area. Such a system comprises an analysis module configured to perform a number of operations in accordance with the invention. The analysis module receives as input at least one multispectral image of the area from respective growing seasons, and for the respective growing seasons the analysis module derives vegetation indices for locations within the area from the multispectral information in the at least one multispectral image and calculates a vegetation index value representative of the area as a whole from the derived vegetation indices for locations within the area. The vegetation index value representative of the area as a whole from the respective growing seasons are then used to quantify a trend in yield potential over time for the area and analyze vegetation sustainability based on the quantified trend.

In some embodiments the analysis module is further configured to receive as input a plurality of cloud-free multispectral satellite images collected close to the peak of at least one growing seasons, and to calculate a vegetation index value representative of the area as a whole for the at least one growing season by calculating a vegetation index value for the respective images for that growing season and selecting the image with maximum vegetation index value for the area as a whole as the vegetation index value representative of the area that growing season.

Embodiments of the computer-based system according to the invention may further comprise a preprocessing module configured to receive as input multispectral satellite images of a geographical region containing the area, and to receive as input or derive from the multispectral satellite images, delineated area boundary information for the area, to apply the delineated area boundary information to remove multispectral information relating to locations outside the area boundary, and to provide the multispectral information relating to locations inside the area boundary as input to the analysis module.

In some embodiments the preprocessing module is configured to derive delineated area boundary information by receiving as input at least one multitemporal, multispectral satellite image sequence from an earth observation satellite system, improving the resolution of the multitemporal, multispectral satellite image sequence with a super-resolution method to generate a high-resolution image sequence where corresponding pixel positions in images in the sequence relate to the same geographical ground position, and using a delineating artificial neural network to classify pixel positions in the high-resolution image sequence as being associated with a geographical ground position that is or is not part of the area.

In some embodiments of the invention the analysis module may be configured to use the vegetation index value to quantify a trend by performing regression analysis on the vegetation index values from the respective growing seasons.

A further module that may be provided in embodiments of a computer-system according to the invention is an output module configured to receive output from the analysis module and to produce a representation of vegetation sustainability. If the trend in yield potential over time is stable or increasing the area is represented as sustainable, and if the trend is negative the area is represented as not sustainable. The output module may further be configured to represent vegetation sustainability using at least one indication selected from the group consisting of: a numerical sustainability index, a color-coded indication of sustainability, and a graph.

### BRIEF DESCRIPTION OF THE DRAWINGS

A detailed description of embodiments will now be given with reference to the drawings where

FIG. 1 is a block diagram of a system representing an embodiment of the invention;

FIG. 2 is a flow chart illustration of steps in embodiments of the invention;

FIG. 3 is a satellite image of an agricultural field being analyzed in accordance with the principles of the invention;

FIG. 4 is a representation of a sequence of images of an agricultural field, where the respective images represent satellite image data obtained at the peak of the growing seasons for which data is available;

FIGS. 5A and 5B show positive and negative trends, respectively, for two agricultural fields;

FIG. 6 is a representation of an area where sustainability for a number of agricultural fields is represented; and

FIG. 7 is an overview of a region where agricultural areas in the region are delineated for analysis in accordance with the invention.

### DETAILED DESCRIPTION

In the following description of embodiments, reference will be made to the drawings, in which like reference numerals denote the same or corresponding elements. The drawings are not necessarily to scale. Instead, certain features may be shown exaggerated in scale or in a somewhat simplified or schematic manner, wherein certain conventional elements may have been left out in the interest of exemplifying the principles of the invention rather than cluttering the drawings with details that do not contribute to the understanding of these principles.

It should be noted that, unless otherwise stated, different features or elements may be combined with each other whether or not they have been described together as part of the same embodiment below. The combination of features or elements in the drawings are intended to facilitate understanding of the invention rather than limit its scope to specific embodiments, and to the extent that alternative elements with substantially the same functionality are shown in respective embodiments, they are intended to be interchangeable. However, for the sake of brevity no attempt has been made to disclose a complete description of all possible permutations of features. As such, the different drawings do not represent embodiments that are alternatives to each other. Instead, the drawings focus, for example, on different aspects or different levels of detail. Alternative embodiments to those shown in the drawings are arrived at by adding features, by removing features, or by configuring features in a different arrangement than that shown in the exemplary drawings. Unless features are explicitly identified as required or they functionally depend on each other to function they may be omitted, reconfigured, or made to interoperate with additional features not described herein in any manner that is within the capabilities and knowledge of a skilled person having studied this disclosure.

Consequently, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention. The term estimate is intended to refer to results that are not directly obtained, for example by measuring on the ground, but arrived at through analysis of related data. As such, analyzing refers to the processing of data in order to arrive at an estimate and estimating means obtaining a result through analysis. Substantially, therefore, the two terms may be understood as referring to the same activities.

References to “one embodiment,” “at least one embodiment,” “an embodiment,” “one example,” “an example”, “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

There are more than 140 basic factors influencing the development of field crops. They include soil organic matter, moisture, soil nutrients, field topography, solar radiation, and many other factors. It is impossible to quantify all those factors and how they interact. Crop yield, however, is a direct result of the influence of all these factors and therefore represents an integrated indication of their combined status. It is, however, quite challenging to collect current and historical yield data and even if it were possible for some fields, a method based on actual historical yield data would not scale. The problem of obtaining yield data would be the same for every additional field; there are no results that can be reused. Instead, fresh data or historical records obtained from yield monitors mounted on harvesters or from final crop production records would have to be collected for each new field to monitor.

It has been realized that green biomass at the peak of the growing season is strongly correlated with actual crop yield. Using a reliable indication of green biomass at the peak of the growing season may therefore be used as an indication of yield and obtaining such an estimate by way of remote sensing would be robust and scalable.

Such an indication is available in the form of vegetation indices obtained based on remote sensing. It may be noted that different crops may have different reflectance patterns, which means that vegetation index alone cannot be directly converted to an estimate of yield. However, vegetation index is normalized and dimensionless, which means that as long as variation between crops over time is somewhat regular over a period of time, it is possible to treat the data statistically without knowing exactly which crop is grown in which year. This will be discussed in further detail below.

The most common application of remote sensing in agriculture is to analyze crop conditions using a combination of near-infrared (NIR) and red parts of the spectrum. Healthy vegetation absorbs more than 80% of the red light, and it also reflects more than 80% of the near-infrared radiation. By comparing the amount of NIR radiation reflected from crop canopy with the amount of red light absorbed by plants, crop conditions for individual fields can be readily estimated. In remote sensing there is a large number of vegetation indices developed for this particular purpose; the most well-known indices are Normalized Difference Vegetation Index (NDVI) and Enhanced Vegetation Index (EVI), but there are others. These are well known to people skilled in the art, and they will not be explained in detail herein.

Spectral indices are excellent indicators of field variability. By analyzing satellite, aerial or drone imagery, areas with higher and lower green biomass can be identified. Moreover, at the peak of the growing season, vegetation indices are strongly correlated with green biomass and grain yield. The present invention is based on use of vegetation indices obtained based on remote sensing, but it does not depend on any specific one of the vegetation indices known in the art. To the extent that embodiments are described herein with reference to any one of them, this will not be intended as a limitation and for all embodiments should be understood as including use of alternative vegetation indices.

Going from vegetation index to yield or biomass estimate is, however, not trivial. Vegetation index value will fluctuate depending on the crop, variety, weather conditions, and other factors. For example, NDVI or EVI values at the peak of the growing season in cereals may be higher than in canola. However, the list of crops in a given geographic region is quite limited. For instance, corn and soybeans are the main crops in the corn belt in the US; wheat, barley and canola are the main crops in the Canadian Prairies. Therefore, multi-year analysis of vegetation indices, such as EVI and NDVI, can give a clear indication of yield trend, and serve as an indication of sustainability of crop production in individual agricultural fields. If the vegetation index trend for a given field is positive, then the nutrient resources in the field are increasing, and crop production in this field is sustainable. If the vegetation index trend for a field is negative, on the other hand, this is an indication that crop production in this field depletes the field resources, such that crop yield decreases over the time, soil resources are being depleted, and crop production is not sustainable over time.

The present invention provides features that help facilitate and streamline creation of long-term crop yield trend estimates, and corresponding evaluation of crop sustainability. The invention makes it possible to do this for individual agricultural fields in a scalable manner, such that inclusion of additional fields does not require significant additional investment of resources. This is achieved based on a combination of several data layers, such as field boundaries and remote sensing data (satellite imagery). The collection of these data layers as well as the processing of the data in order to obtain the desired results and generate the required output is based on automation and achieves scalability in a manner that is not available with existing methods.

The method provided by the invention may also be utilized on a larger scale than individual agricultural fields. The invention will first be explained in terms of examples relating to agricultural fields. Application to larger areas such as farmland areas, forests, or even on a regional or national scale will then be explained. In the description of examples, the terms field boundary, field sustainability and field or agricultural field will be used, while more generally these terms may be replaced by area boundary, vegetation sustainability and area or vegetation area may be used. These terms are intended to refer to different contexts, not different embodiments and as such the terms are interchangeable. Both the term field and the term area, whether they are used in the singular or the plural, are intended to include contiguous as well as non-contiguous areas, such that the terms field or area may refer to non-contiguous areas, and the terms fields or areas are intended to include cases with only one single, contiguous area.

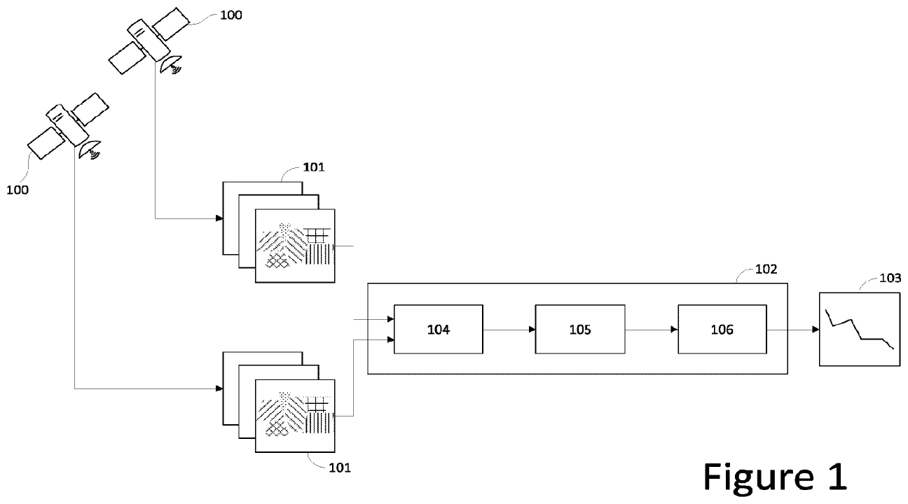

Reference is first made to FIG. 1 which illustrates how satellite images of agricultural fields may be obtained using earth observation satellites 100. Earth observation satellites are satellites used for Earth observation from orbit. Non-military uses of Earth observation satellites include environmental monitoring, meteorology, cartography, and more. Existing systems include the Landsat program, which is a joint NASA and United States Geological Survey (USGS) program, the Moderate Resolution Imaging Spectroradiometer (MODIS) sensor launched into orbit by NASA, Sentinel-1 and Sentinel-2 which are part of the European Space Agency's Copernicus Programme, WorldView-1 and WorldView-2 owned by DigitalGlobe, as well as systems and services provided by Maxar Technologies and Planet Labs.

Multiple multitemporal multispectral satellite imaging data sequences are provided by one or several satellites or systems of satellites 100, such as the ones mentioned above. In this context, multiple sequences means that they are obtained from multiple growing seasons, typically multiple years. The data sequences 101 are delivered as input to a processing system 102 which processes the data in order to determine field sustainability and provides the results as output 103.

The image sequences 101 may be obtained from several different sources but obtaining images from only one source may simplify or remove the need for calibration and help ensure that images obtained at different points in time are comparable, i.e., that differences between the images are representative of differences on the ground over time. Image data sequences 101 obtained in different growing seasons are provided as input to a preprocessing module 104 in the processing system 102. The image data sequences 101 should represent approximately the same time period of each growing season, for example around the peak of the growing season. The preprocessing module 104 is configured to delineate agricultural fields such that image data can be associated with specific fields and sustainability can be determined on a per field basis. This may be done by applying field boundary information to satellite images of a geographical region containing an agricultural field of interest and removing multispectral information that is outside the field boundary. It should be noted that the word removed in this context does not necessarily mean deleting. It is sufficient that data not relating to the currently processed field is identifiable as irrelevant and thus excluded from the further processing of information relating to that field. The preprocessing module 104 may also calibrate the received images and select a sequence of images that are likely to include the image which will result in the highest vegetation index from each growing season. In other words, one sequence of images is selected from each growing season and each such sequence should likely include the image which will give the highest vegetation index for that season. The selected images are forwarded to an analysis module 105 which performs the analysis that will be described in further detail below. The result of the analysis is provided to an output module s which generates a representation of field sustainability development over time.

In terms of physical structure, the various modules in FIG. 1 may be comprised of software and hardware combinations which implement communication interfaces and protocols, image processing capabilities, and so on. The physical hardware may include processors, storage units, communication buses, peripherals and user interfaces such as displays, keyboards, touchscreens, and more. These and other devices and components are well known in the art and will not be described in further detail.

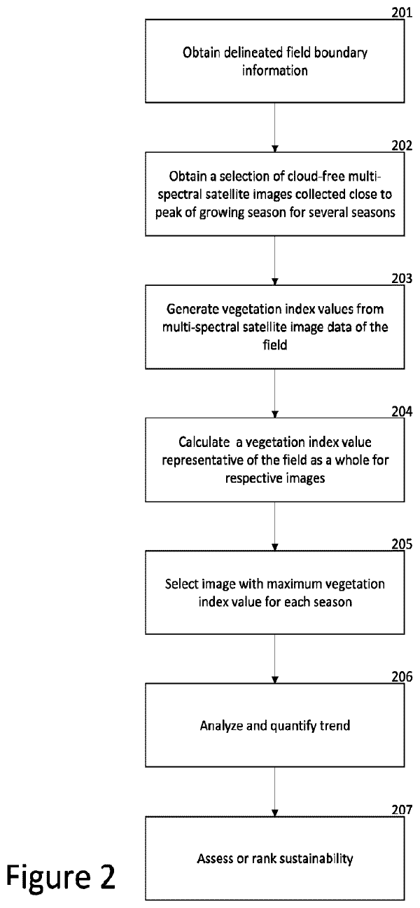

FIG. 2 which is a flow chart illustration of the main steps in a method consistent with the principles of the invention. This method may be performed by the processing system 102. It should be understood that the overview presented with reference to this drawing may include details that are not necessarily part of all embodiments of the invention, and, conversely, that some details may be left out from the description of this overview while they may be described with reference to other drawings. This should not be interpreted as representing different embodiments. Rather, the overview represented by FIG. 2 is intended to provide an understanding of the overall flow of information and performance of steps. Some of these steps may be common to most embodiments, while some may be optional, or they may have been performed prior to or will be performed subsequent to the steps performed by a specific embodiment of the invention. For example, some embodiments may include steps to obtain satellite images from which field delineation is performed while other embodiments are simply able to access field delineation data from a repository of such information. The same is the case for larger areas, where delineation may be derived from information content in the multispectral images themselves or obtained from a database or other repository of boundary information. Details and various embodiments will be discussed when the respective steps of FIG. 2 are explained in further detail with reference to the additional drawings.

When steps are referred to first, second, and so on in order to identify them from each other, not in order to prescribe a specific sequence. Whether a particular step must be performed before or subsequent to another step depends on whether one of the steps relies on, i.e., takes as input, the results, i.e., the output, of another step. And even when this is the case it does not necessarily follow that the prior step needs to be completed before the subsequent step can commence. Instead, in some cases or embodiments a step may provide a partial result before it concludes, and the subsequent step may be initiated with the partial results before the prior step is completed.

In a first step 201 of the method illustrated in FIG. 2 field boundary delineation is performed. The purpose of this step is to provide accurate, georeferenced field delineation information. Simply speaking, this step obtains information that specifies the exact location and shape of a particular field. What “exact” means in terms of accuracy may, of course, vary according to needs. The point is to obtain information that is sufficiently accurate to support the other steps of the method and enable a final result that is sufficiently accurate to give a good estimate of the sustainability of the field in question. When the invention is applied to larger areas than individual fields, the requirements for accuracy may be lower.

Several methods of field delineation are known in the art, and the invention does not depend on any specific one of them. One suitable method is described in Norwegian patent application No. 20211116 and corresponding applications in other countries. This method involves obtaining at least one multitemporal, multispectral satellite image sequence from earth observation satellites. The obtained images are pre-processed to generate a pre-processed image sequence of multitemporal multispectral images covering a specific geographical region containing at least one agricultural field of interest. A super-resolution method may be used on the images in the pre-processed image sequence to generate a high-resolution image sequence where corresponding pixel positions in images in the sequence relate to the same geographical ground position. A delineating artificial neural network is then used to classify pixel positions in the high-resolution image sequence as being associated with a geographical ground position that is or is not part of an agricultural field.

The content of the above-mentioned patent application is hereby incorporated by reference, but as already mentioned the present invention may utilize other methods for field delineation. In some embodiments delineation may be performed using, for example, the method referenced above on input data that is also used to source the data used by the present invention. In other embodiments the delineation information is already available and accessible to the preprocessing module 104.

In a second step 202 a selection of cloud-free multi-spectral satellite images are obtained. These images may be selected from input data 101 by the preprocessing module 104 and they should be selected such that they are representative of the status of the vegetation in a given field close to the peak of the growing season for each growing season covered. This means that for each growing season several images should be selected, and the selection should include at least one image obtained at or near the peak of the growing season and therefore be the image likely to result in the highest vegetation index for that field in that season. In order to obtain high quality and comparable results the images should come from the same source, for example from the same satellite system (Landsat 8, Sentinel 2, etc.). The fact that the results provided by the invention is a trend means that it is normally not necessary to calibrate for variations that are short term. Such variations may relate to drought, crop variation (e.g., change in variety), and other known factors. Selection of sources for multispectral images and the topic of calibration will be discussed in further detail below. If images are obtained from several sources, it will be more difficult for the preprocessing module 104 to perform adequate calibration or for the analysis to produce a reliable trend, but it is within the scope of the invention to use images from several sources. The selected and preprocessed images sequence data may now be forwarded to the analysis module 105.

In a third step 203 vegetation index values are calculated from the obtained multispectral image data of the field. The field delineation information from the first step 201 and the multispectral images selected in the second step 202 are used to generate vegetation indices for the area inside the boundary of respective fields for the selected images. The vegetation index may be Normalized Difference Vegetation Index (NDVI, Enhanced Vegetation Index (EVI), or any other spectral indices obtained from remote sensing data which show variability of green biomass and, therefore, yield potential across the field. The growing seasons will typically be years, but some areas are capable of producing several crops per year. In that case it may be sufficient to select one of these growing seasons to represent respective years, but it is consistent with the principles of the invention to include growing seasons that are not one year apart.

For the selected images from step 202 a representative vegetation index for the entire field is calculated, for example the average vegetation index for all or a selection of pixels inside the field boundary obtained in the first step 201. Thus, the result of the third step 203 is a table (or sequence) of multiple field-average vegetation index values for each growing season.

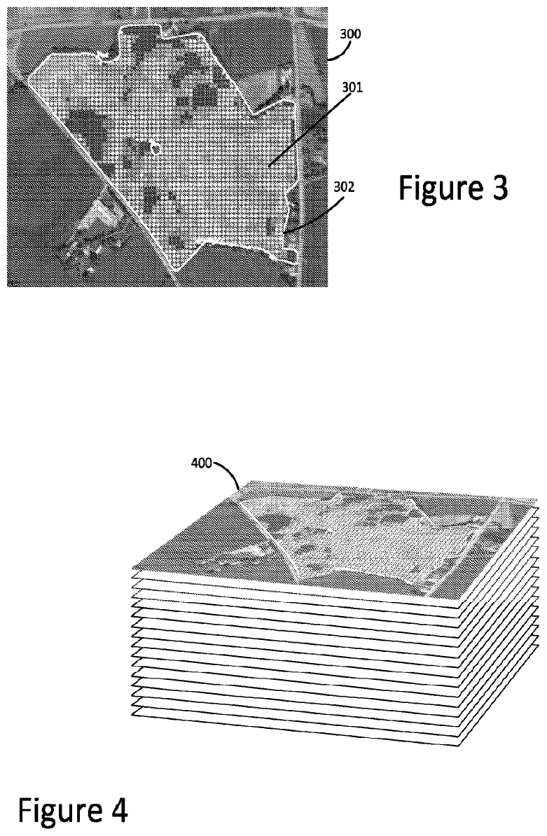

FIG. 3 shows an example of an image during performance of the third step. An image 300 obtained in the second step 202 includes a field 301 that is delineated by a boundary 302 obtained in the first step 201. Inside the boundary there are a number of pixels representative of a small area of the field. The images will be georeferenced such that there will be a known relationship between a pixel position in an image and a true location in the agricultural field. Each pixel includes the multispectral information necessary for calculation of a vegetation index value. In this example different values are represented by different shades of gray. Other representations are, of course, possible. However, it should be understood that for the purposes of the present invention the graphical representation is not important. It is the values that can be calculated from the information content in the images that is utilized.

Returning now to FIG. 2, in a fourth step 204 the highest vegetation index result for each growing season is selected. The selected value is assumed to correspond to the largest amount of green biomass present in the field during the growing season and thus to represent an indication of the productivity of the field in that growing season. It should be noted that the vegetation index is a unit-less value that does not provide a measure of any physical amount, neither of green biomass nor of crop yield. However, the vegetation is expected to correlate with these. If the vegetation index changes over a number of growing seasons this is therefore likely to correspond to an increase or decrease in field productivity.

The selection of one image per growing season may be visualized as in FIG. 4 where a stack of images 400 represents satellite image data selected for each growing season from which data is available. Internally in the analysis module 105 this data will, of course, be represented for example as a three-dimensional data array or some other data structure where each entry represents a pixel which is associated with a point in time and a point (or small area) in the agricultural field. Thus, each growing season is represented by one image, namely the image that has the highest vegetation index result for the agricultural field being evaluated.

The table below shows exemplary results for a period of 38 years with one growing season per year for two different fields. In this example EVI has been chosen. An advantage EVI may have over NDVI at least in some situations, is that NDVI may saturate in fields with high canopy density and therefore makes it difficult to detect small changes in crop canopy development.

| | |
|---|---|
| Field 1 (positive trend) | Field 2 (Negative trend) |

| Year | Average EVI | Year | Average EVI |
|---|---|---|---|
| 1984 | 5400 | 1984 | 8100 |
| 1985 | 5800 | 1985 | 8000 |
| 1986 | 5300 | 1986 | 7300 |
| 1987 | 6000 | 1987 | 7800 |
| 1988 | 6500 | 1988 | 7200 |
| 1989 | 6100 | 1989 | 7700 |
| 1990 | 7100 | 1990 | 6800 |
| 1991 | 6400 | 1991 | 7500 |
| 1992 | 6800 | 1992 | 7300 |
| 1993 | 6700 | 1993 | 7450 |
| 1994 | 7000 | 1994 | 6900 |
| 1995 | 6900 | 1995 | 7700 |
| 1996 | 7000 | 1996 | 7200 |
| 1997 | 7200 | 1997 | 7800 |
| 1998 | 6600 | 1998 | 7100 |
| 1999 | 7250 | 1999 | 6800 |
| 2000 | 7300 | 2000 | 6900 |
| 2001 | 6900 | 2001 | 7500 |
| 2002 | 7200 | 2002 | 7400 |
| 2003 | 7400 | 2003 | 7100 |
| 2004 | 7500 | 2004 | 6800 |
| 2005 | 6800 | 2005 | 7400 |
| 2006 | 6900 | 2006 | 7200 |
| 2007 | 7200 | 2007 | 6500 |
| 2008 | 7750 | 2008 | 7200 |
| 2009 | 7100 | 2009 | 7000 |
| 2010 | 7800 | 2010 | 6800 |
| 2011 | 6800 | 2011 | 7000 |
| 2012 | 7300 | 2012 | 6000 |
| 2013 | 7400 | 2013 | 6900 |
| 2014 | 7550 | 2014 | 6400 |
| 2015 | 6900 | 2015 | 7200 |
| 2016 | 7650 | 2016 | 6150 |
| 2017 | 7400 | 2017 | 6600 |
| 2018 | 7700 | 2018 | 6000 |
| 2019 | 7200 | 2019 | 5400 |
| 2020 | 7950 | 2020 | 5700 |
| 2021 | 8000 | 2021 | 5600 |

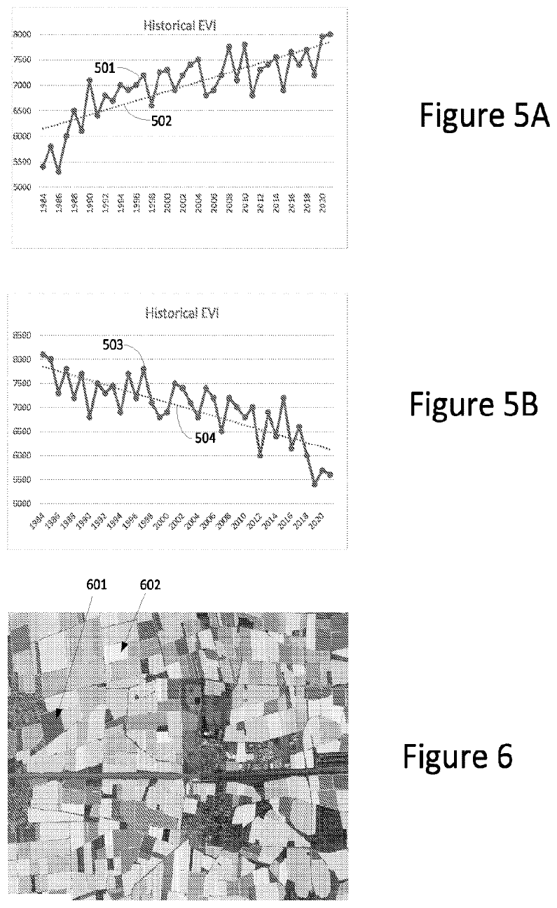

In a fifth step 205 the results are analyzed, and trends are quantified. This is exemplified with graphical representations in FIG. 5A and FIG. 5B. These drawings illustrate how the first field shows a positive trend, while the trend for the second field is negative. In FIG. 5A the curve 501 is a representation of the index results for field 1 in the table above, while in FIG. 5B the curve 503 is a representation of the index results for field 2.

The numbers may be processed further in order to provide more detailed insights into the development of each analyzed field. Simple regression analysis may be performed, where the vegetation index serves as dependent variable, and the growing season (in this example, and typically, the year) is an independent variable. This will provide the coefficient of regression line slope. This coefficient is an ideal indication of crop production sustainability: regardless to the crops grown in a given field and the geographic region, the coefficient will provide an indication of crop productivity for respective fields to the same scale, meaning that it can be applied to analysis of fields globally and results will be comparable.

For the example given in the table above the described analysis will provide the following results:

Equation for field 1 (positive trend, sustainable field management):

$${y}_{1} = 45.9733 * Year - 85068.1$$

Equation 2 (negative trend, unsustainable field management):

$${y}_{2} = - 4 6.5587 * Year - 100218.$$

These two equations are shown as trendlines in FIG. 5A and FIG. 5B where y₁ is shown as the line 502 in FIG. 5A and y₂ is shown as the line 504 in FIG. 5B.

In this example the coefficient for the first equation, 45.9733, is the sustainability index for the first field. This normalized index is positive; therefore, crop production in this field is sustainable.

The coefficient in the second equation, −46.5587, is negative. This indicates that the field resources are being depleted, and the field cannot sustain the same level of production in the future.

The time period selected in this case is, as already mentioned, 38 years, which is the period all the way back to 1984 which is the beginning of availability for Landsat data. In a sixth step 206 any time period for which data is available may be selected and the results from the analysis described above may be used in order to identify trends and in order to compare and rank 207 the status for multiple fields. Ranking may, for example, be done for 3-year, 10 year, and 20-year periods, or for all available data.

It will be understood that the result of the process described above is a sustainability index for each field that is evaluated in accordance with the invention. Fields with a positive sustainability index are improving in terms of productivity and are therefore sustainable, while fields with a negative sustainability are being depleted and are not being managed in a sustainable manner. A possible output 103 from the output module 106 is therefore a map of an area where different fields are color coded in accordance with their sustainability index. For example, fields with a positive sustainability index may be green while fields with a negative sustainability index may be red. The magnitude of the index may be represented by the intensity of the color such that dark green is very sustainable, light green is barely sustainable, light red is slightly unsustainable, and dark red represents very unsustainable. Thus, the sustainability index is a representation of an estimate of sustainability over time derived from an analysis of multispectral input data.

FIG. 6 is an illustration of an area that has been analyzed in this manner. The results were produced by analyzing an area near Hannover, Germany with a size of 40 km×40 km and with NDVI data from 1984 to 2021. FIG. 6 shows a part of this area where, for example, field 601 is very unsustainable, while field 602 is barely sustainable. Since representation here is in greyscale it is not possible to distinguish green from red, but the image shows that fields are immediately identifiable and may be distinguished from each other, and it will be readily understood that the addition of color will provide the information that is lost in greyscale. (Of course, it would be possible to represent sustainable fields as light grey and unsustainable fields as dark grey or vice versa instead of using different colors.)

As mentioned above, the sources of available multispectral images that may be used in conjunction with the present invention primarily include multispectral satellite images, such as Landsat 4, 5, 7, 8, 9, Sentinel 2, and any other existing or future satellite systems. If all images are from the same source, e.g., from the same satellite system, the need for calibration is limited. Variations caused by crop rotation, for example, usually repeats in a consistent pattern. This means that even if the vegetation index varies from one year to the next it does so in a pattern that is repeated over a period of years. For longer periods of time, for example more than 10 years, the trend will not be influenced by this short-term variation. The same will be the case for summer fallow, drought, and other factors that may have impact on the field for a short period of time but no long-term impact. (Or, conversely, factors that have long-term impact may be considered factors that have had an impact on field sustainability and therefore should be reflected in the trend.)

The images may still need to be radiometrically calibrated and atmospherically corrected. If images from different satellite systems are used the images should be radiometrically cross-calibrated. Provided that sufficient calibration is possible, it is within the scope of the invention to process images from other sources than satellite systems using the methods described herein. Such sources may for example include drones or airplane photography. If adequate calibration is not possible, for example because of too many uncontrollable variables, the results may, however, be of limited value. may be used.

As mentioned above, the principles explained with reference to the drawings may be applied by using the same approach for assessing the sustainability of agriculture or vegetation in general at the levels of specific farmland regions, forests, municipalities, or even at the country level. This requires a consistent definition of the area being analyzed. In particular it may be necessary to avoid inclusion of areas with different types of vegetation that make it difficult to define a consistent time of year as representing the peak of the growing season. Similarly, if subareas within the analyzed area are permanently changing from one type of vegetation to another, for example from forest to farmland, it is necessary to know how this will influence the vegetation index in order to enable a sound interpretation of the results. It must also be understood that with large areas including different types of vegetation, trends may go in opposite directions and partly cancel each other out.

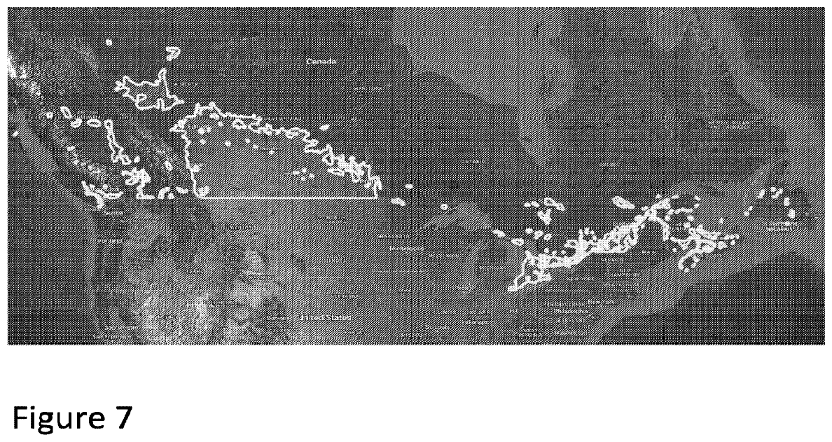

With this in mind, an area may be delineated based on official farmland boundaries that may be available from government departments such as Agriculture and Agri-Food Canada (AAFC) and similar organizations in other countries, from mapping agencies, etc. FIG. 7 is an illustration showing farmlands in Canada with boundary information from the AAFC. Based on this delineation and multispectral satellite images it is possible to derive vegetation indices for locations within the agricultural areas and calculate a vegetation index that is representative for the areas as a whole from vegetation indices for representative locations, in the same manner as for individual fields as described above.

When using a method according to the invention for assessing the sustainability of agriculture at the country level, or at the levels of different municipalities or regions within the country, the trend is analyzed using the maximum average vegetation index value from the selected area(s). A positive trend at the chosen level indicates sustainable crop production, whereas a negative vegetation index trend is an indicator of unsustainable agriculture and depletion of the natural resources. The trend will, of course, only represent an average state of sustainability and subareas may develop differently than the chosen area as a whole.

The chosen area does not have to be agricultural. If the chosen area is forest the trend may indicate increase or decrease of biomass, including deforestation. If the area is arid, a negative trend may be indicative of desertification. If the area includes several vegetation types or regions the trend may be indicative of spread of one type at the expense of another, for example as a result of human activities or climate change.

For sustainability indices at a large scale, for example at the country scale, lower resolution may be used for current and historical imagery. This means that images provided by satellite sensors such as VIIRS, MODIS, and AVHRR may be sufficient even if they do not provide sufficient resolution for individual fields. The requirements for imagery calibration at the country scale are the same as for the field level.

1. A method in a computer system for estimating vegetation sustainability for an area (301), comprising:
obtaining (202) at least one multispectral image (101) of the area (301) from respective growing seasons;
for the respective growing seasons:
deriving (203) vegetation indices for locations within the area (301) from the multispectral information in the at least one multispectral image; and
calculating (204) a vegetation index value (501, 503) representative of the area (301) as a whole from the derived vegetation indices for locations within the area (301); and
using the vegetation index value (501, 503) representative of the area as a whole from the respective growing seasons to quantify (206) a trend (502, 504) in yield potential over time for the area (301) and to provide a sustainability index based on the quantified trend (502, 504).

2. A method according to claim 1, wherein
the step of obtaining (202) at least one multispectral image (101) of the area from respective growing seasons includes obtaining a plurality of cloud-free multispectral satellite images collected close to the peak of at least one growing season; and
the step of calculating (204) a vegetation index value (501, 503) representative of the area (301) as a whole for the at least one growing season includes calculating a vegetation index value (501, 503) for the respective images for that growing season and selecting (205) the image (101) with maximum vegetation index value (501, 503) for the area (301) as a whole as representative of that growing season.

3. A method according to claim 1, further comprising:
obtaining (201) delineated area boundary information (302); and
wherein the step of obtaining (202) at least one multispectral image (101) of the area (301) from a plurality of growing seasons includes applying the delineated area boundary information to remove multispectral information relating to locations outside the area boundary.

4. A method according to claim 3, wherein step of obtaining delineated area boundary information (302) includes:
obtaining at least one multitemporal, multispectral satellite image sequence from an earth observation satellite system (100);
improving the resolution of the multitemporal, multispectral satellite image sequence with a super-resolution method to generate a high-resolution image sequence where corresponding pixel positions in images in the sequence relate to the same geographical ground position; and
using a delineating artificial neural network to classify pixel positions in the high-resolution image sequence as being associated with a geographical ground position that is or is not part of the area.

5. A method according to claim 3, wherein the step of obtaining delineated area boundary information (302) includes obtaining boundary data from a database.

6. A method according to claim 1, wherein the step of using the vegetation index value (501, 503) to quantify a trend includes performing regression analysis on the vegetation index values (501, 503) from the respective growing seasons.

7. A method according to claim 1, wherein if the trend (502, 504) in yield potential over time is stable or increasing the area is sustainable, and if the trend is negative the area is not sustainable.

8. A method according to claim 1, wherein the area is a contiguous or non-contiguous area selected from the group consisting of: an agricultural field, a municipal area, an agricultural area, a forest, and a vegetation region.

9. A computer-based system for estimating vegetation sustainability for an area (301), comprising:
an analysis module (105) configured to:
receive as input at least one multispectral image (101) of the area (301) from respective growing seasons;
for the respective growing seasons:
derive (203) vegetation indices for locations within the area (301) from the multispectral information in the at least one multispectral image; and
calculate (204) a vegetation index value (501, 503) representative of the area (301) as a whole from the derived vegetation indices for locations within the area (301); and
use the vegetation index value (501, 503) representative of the area as a whole from the respective growing seasons to quantify (206) a trend (502, 504) in yield potential over time for the area (301) and analyze vegetation sustainability based on the quantified trend (502, 504).

10. A computer-based system according to claim 9, wherein the analysis module (105) is further configured to:
receive as input a plurality of cloud-free multispectral satellite images collected close to the peak of at least one growing seasons; and
calculate (204) a vegetation index value (501, 503) representative of the area (301) as a whole for the at least one growing season by calculating a vegetation index value (501, 503) for the respective images for that growing season and selecting (205) the image (101) with maximum vegetation index value (501, 503) for the area (301) as a whole as the vegetation index value representative of the area that growing season.

11. A computer-based system according to claim 9, further comprising:
a preprocessing module (104) configured to receive as input multispectral satellite images of a geographical region containing the area, and to receive as input or derive from the multispectral satellite images, delineated area boundary information (302) for the area;
to apply the delineated area boundary information to remove multispectral information relating to locations outside the area boundary; and
to provide the multispectral information relating to locations inside the area boundary as input to the analysis module (105).

12. A computer-based system according to claim 11, wherein the preprocessing module (104) is configured to derive delineated area boundary information (302) by:
receiving as input at least one multitemporal, multispectral satellite image sequence from an earth observation satellite system (100);
improving the resolution of the multitemporal, multispectral satellite image sequence with a super-resolution method to generate a high-resolution image sequence where corresponding pixel positions in images in the sequence relate to the same geographical ground position; and
using a delineating artificial neural network to classify pixel positions in the high-resolution image sequence as being associated with a geographical ground position that is or is not part of the area.

13. A computer-based system according to claim 9, wherein the analysis module (105) is configured to use the vegetation index value (501, 503) to quantify a trend by performing regression analysis on the vegetation index values (501, 503) from the respective growing seasons.

14. A computer-based system according to claim 9 further comprising an output module (106) configured to receive output from the analysis module (105) and to produce a representation of vegetation sustainability, wherein if the trend (502, 504) in yield potential over time is stable or increasing the area is represented as sustainable, and if the trend is negative the area is represented as not sustainable.

15. A computer-based system according to claim 14, wherein the output module (106) is configured to represent vegetation sustainability using at least one indication selected from the group consisting of: a numerical sustainability index, a color-coded indication of sustainability, and a graph.
